(19) United States
(12) Patent Application Publication
(10) Pub. No.: US 2015/0025968 A1
(43) Pub. Date: Jan. 22, 2015

(54) DATA MANAGEMENT PROCESS UTILIZING A FIRST-PARTY TECHNIQUE

(71) Applicants: Martin Gregory Smith, Lafayette, CO (US); Ronald John Hill, Broomfield, CO (US); Jim Bob Oney, Commerce City, CO (US); Gregory James Neal, Evergreen, CO (US); Scott Michael Alfred Kozub, Westminster, CO (US)

(72) Inventors: Martin Gregory Smith, Lafayette, CO (US); Ronald John Hill, Broomfield, CO (US); Jim Bob Oney, Commerce City, CO (US); Gregory James Neal, Evergreen, CO (US); Scott Michael Alfred Kozub, Westminster, CO (US)

(73) Assignee: TRUEFFECT, INC., Westminster, CO (US)

(21) Appl. No.: 14/188,523

(22) Filed: Feb. 24, 2014

Related U.S. Application Data
(60) Provisional application No. 61/767,802, filed on Feb. 22, 2013.

(51) Int. Cl. G06Q 30/02; H04L 29/08

(52) U.S. Cl. CPC G06Q 30/0255; H04L 67/22
USPC 705/14.53

(57) ABSTRACT

Internet users are becoming more aware of data transfer through third-party cookies to multiple publisher sites without their consent. Subsequently, they are taking action to block or delete third-party cookies through browser controls or automated anti-spyware programs. This blocking and deleting process reduces the ability of third-party networks to accurately target users for relevant advertising. First-party cookies are less susceptible to cookie deletion and are therefore able to provide better targeting for more relevant ad delivery. There is an extended opportunity for “Trusted” First-Party networks to share non-Personally Identifiable Information (non-PII) across the network to prevent data leakage outside the trusted partners. For example, a large corporation with multiple companies that have either their own domains (domain1.com, domain2.com) or multiple subdomains (product1.domain.com, product2.domain.com) may want to share user segmentation and propensity information across their companies for cross/up sell purposes. The invention claims the benefit of U.S. Pat. No. 7,904,520, granted Mar. 8, 2011, entitled “First Party Advertisement Serving,” to leverage information in the first-party cookie mode across trusted domains and subdomains.

### CROSS-REFERENCE TO RELATED APPLICATIONS

This application claims the benefit of U.S. provisional application No. 61/767,802 entitled “Data Management Process Utilizing a First Party Technique” filed Feb. 22, 2013, which is hereby incorporated by reference as though fully set forth herein.

This application is related to U.S. Pat. No. 7,904,520, granted Mar. 8, 2011, entitled “First Party Advertisement Serving” and U.S. Pat. No. 8,583,749 granted Nov. 12, 2013 entitled “First Party Advertisement Service,” each of which is incorporated herein by reference for all purposes.

This application is also related to U.S. patent application Ser. No. 12/629,842 entitled “Cookie Derivatives” and filed on Dec. 2, 2009; Ser. No. 13/934,203 entitled “Enhanced Adserving Metric Determination” and filed on Jul. 2, 2013; Ser. No. 13/934,204 entitled “Enhanced Adserving Metric Determination” and filed on Jul. 2, 2013; and Ser. No. 13/934,206 entitled “Enhanced Adserving Metric Determination” and filed on Jul. 2, 2013, each of which is hereby incorporated by reference as though fully set forth herein.

### TECHNICAL FIELD

Implementations of the present invention relate generally to aggregating data from multiple online and/or offline sources for use in first party data (e.g., in a first party cookie) to store user propensity information, such as but not limited to user propensity segments or themes and serve content based upon that information.

### BACKGROUND

Advertising via the Internet continues to grow and evolve at a rapid pace. Internet browser technology has evolved to respond to security and privacy concerns as well as provide new device extensions. Internet advertising methodologies have generally relied on Internet cookies to track the users to determine how many times they have been exposed to ads and which ads to serve next. More specifically, the methodologies have generally relied on third-party Internet cookie tracking because the vast majority of tracking companies utilize cookies, within their own domain, to serve Internet ads and track their performance. In many cases, information such as product interest on an advertiser site domain is transferred to the ad server site domain via the third-party cookies to be used for ad targeting purposes. Internet users and are becoming increasingly aware of the data transfer and object to the transfer without their knowledge and permission. For example, if you visit a first domain, Domain1.com, you will get various first-party cookies set by the Domain1.com site partners and internal systems as well as many third-party cookies set by their advertising and tracking partners. In many cases information about your interests on the advertiser site are shared with the third-party for subsequent advertising decisions. To be more specific, if a user visits a “big box” retailer website and views a 55″ TV from a major brand and then goes to their webmail provider to check their internet-based email, chances are high that the information about their interest in a specific TV was set in a third-party cookie in the domain of the webmail provider. Accordingly, the webmail provider will deliver an ad that is consistent with the 55″ TV that was viewed on the retailer site. Interestingly, if the user hits the refresh button a few times they may get the same ad from the same vendor but then, after a few more refreshes the user may get an ad for the same or similar TV from a different vendor. In this scenario, the information about the user's interests was transferred to the webmail vendor. Initially, the webmail vendor (ad network) sold the user's interest and the ad space to the original advertiser. Subsequently, they sold that same interest and ad space to a competing advertiser. Essentially, the user's interests were transferred to the webmail vendor and then sold without the user's knowledge or permission.

In response to objections about third-party tracking, browser makers have enhanced access to cookie controls to enable the user to: 1) block all cookies; 2) block third-party cookies; 3) allow all cookies. Some mobile browsers are set by default to block third-party cookies and only allow first-party cookies. Standard internet advertising practices use third-party cookies to track internet ad exposure and in some cases, store user preferences to help determine which ads will be most relevant to the user. A problem encountered in tracking ad views and storing user preferences using third-party cookies is that if third-party cookies are blocked or deleted, such as by a browser or secondary anti-spyware programs, the tracking accuracy drops and the user preferences for targeting are eliminated. This behavior causes ad counting for reach and frequency purposes to be incorrect and ad relevance to be inconsistent because there is no behavior to match. Interestingly, first-party cookie counting is less susceptible to automated cookie blocking and deletion than third-party cookie tracking because users are more comfortable with cookies from companies they know and trust.

Common internet advertising practices include building a Consortium “third-party” database of user propensity segments by gathering information from multiple advertiser sites. The basis of the Consortium is that by sharing user propensity and “in-market” information, essentially, you may be giving your competitors a lead but you may also be getting a lead from them. There may also be an opportunity to cross-sell or up-sell a user that is in-market for a product that is complementary to your product which may increase your sales as well.

### SUMMARY

Implementations provided herein relate generally to aggregating data from multiple online and/or offline sources for use in first party data (e.g., in a first party cookie) to store user propensity information, such as but not limited to user propensity segments or themes and serve content based upon that information. In one implementation, for example, a database is used to aggregate data from multiple online and/or offline sources and then use the first-party information (e.g., a first party cookie) to store user propensity segments or themes and serve ads based on those segments or themes. In some implementations, data segments are transferred without Personally Identifiable Information (PII) in a consortium or master database to first-party information (e.g., cookies) from each slave database or consortium member. The data within the first party information (e.g., cookies) is the used to serve ads based on user interests to provide “relevant” ads which generate higher click rates and subsequent sales.

Internet content sites have made money by selling advertising across their site and their associated network sites. The content providers have become increasingly good at capturing behavioral data on users to be used for behavioral targeting. The more data a content provider has on a user the more they can charge for the behaviorally targeted segments because those customers have demonstrated “in-market” behavior and generally the match of targeted ads with “in-market” customers helps increase the effectiveness of the ads. The more detailed and timely information is on a user, the more that information is worth to an advertiser. The sites build their behaviorally targeted information in a few different ways: 1) from internal surfing behavior across their site or network of sites and; 2) from the advertisers where a user has demonstrated interest in specific products. In the second scenario, the advertiser allows the publisher to place scripts (e.g., JavaScript) on their pages which place publisher cookies on the users' browser.

Consequently, there is increasing pressure on the industry to provide access to privacy controls for the user to be able to limit the data transfer to unknown third-parties which include, in many cases the content sites. Generally, users will trust first-parties, such as a site they visited to purchase a product, but not trust third-parties, such as an ad serving network with their information.

In one implementation, a first-party data management system and process provides a system and process for maintaining advertiser propensity segment information within an advertiser database. In one implementation, for example, an advertiser database comprises a first party cookie domain structure. In this implementation, the advertiser database allows the information to be shared within a private marketing consortium database to limit the data exchange with traditional ad networks and exchange services. Ultimately, this process increases privacy by eliminating the need to transfer information outside a single domain or a private network with participating companies known to the advertiser.

One difference between a third-party based network and a first-party based network is that a user establishes a relationship with an advertiser within the first-party network for the enhanced targeting to be used. No data is transferred outside the first-party network to external third-parties.

In one implementation, an advertiser adds a first-party ad serving company to a first party domain (e.g., adds the first-party ad serving company to the advertiser's DNS list) so that the ad serving company is able to read and write cookies within the advertiser domain (First-Party). Subsequently, if a user visits an advertiser site (Domain1.com) they may get an advertiser cookie in the first-party domain (Domain1.com). If the user then goes to their browser-based email, and the ad server is called for an ad in the first-party domain (Domain1.com), the ad server can read the Domain1.com cookie and make the appropriate ad serving decisions based on the contents of the cookie. For example, if the user is a high value customer of the advertiser they may put a cookie on the users browser with the one of the fields having the contents of user=high_value. Or user=recent_{—}55″_LED_TV in this case the ad server would know to serve the ad for the 55″ LED TV.

The first-party cookie is subject to the browser cookie security settings but is effected differently than the third-party cookie in the following manner: 1) if the browser setting is set to accept all cookies, the behavior will be the same, 2) if the browser is set to reject third-party cookies, the first-party cookie can be set in the advertiser domain and read in other domains but not written in the other domains. A third-party cookie will be rejected in all domains, 3) if the browser is set to reject all cookies, then no cookies are set and the first-party and third-party cookies will be affected in the same manner.

In another implementation, a first-party data management system allows an advertiser to maintain the advertiser propensity segment information within the advertiser's own advertiser data management platform database and cookie domain structure or share the information within a private marketing consortium database to limit the data exchange with traditional advertiser networks and exchange services.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Other features, details, utilities, and advantages of the claimed subject matter will be apparent from the following more particular written Detailed Description of various embodiments and implementations as further illustrated in the accompanying drawings and defined in the appended claims.

### BRIEF DESCRIPTION OF THE DRAWINGS

FIG. 1 illustrates a suitable operating environment in which embodiments of the Server-Side First-Party Multi-Domain Network invention may be implemented.

FIG. 2 illustrates a suitable operating environment in which embodiments of the Client-Side First-Party Multi-Domain Network invention may be implemented.

FIG. 3 illustrates a suitable operating environment in which embodiments of the Server-Side First-Party Multi-Sub-Domain Network invention may be implemented.

FIG. 4 illustrates a suitable operating environment in which embodiments of the Client-Side First-Party Multi-Sub-Domain Network invention may be implemented.

FIG. 5 illustrates a suitable operating environment in which embodiments of the Third-Party Network may be implemented.

FIG. 6 illustrates a suitable operating environment for Setting/Reading First-Party cookies through Email.

FIG. 7 illustrates a suitable operating environment for a Domain Segment Manager Update Process.

FIG. 8 illustrates a third-party cookie model vs. a first-party cookie model.

FIG. 9 is a flow chart of an advertiser site setting their first-party cookie. (including a first-party ad serving cookie) along with a synchronized first-party consortium cookie.

FIG. 9B is a flow chart of a multiple first-party domain request process.

FIG. 10 illustrates a block diagram of a multiple first party domain request process.

FIG. 11 illustrates an example general purpose computing system in which one or more implementations described herein may execute.

### DETAILED DESCRIPTION

U.S. Pat. No. 7,904,520 entitled “First Party Advertisement Serving” issued Mar. 8, 2011 to Neal et al. describes various first-party advertisement serving techniques and is incorporated by reference herein in its entirety. As described herein, these techniques can be useful in improved protection, control and efficiency of managing user profiles for ad tracking and serving on the internet. It also provides enhanced media performance because first-party cookies get deleted less than third-party cookies. Essentially, transferring your first-party profiles to third-party cookies reduces the available inventory of your customers causing you to purchase more inventory to find the same amount of customers across the web. First-party cookies can also help enhance the relationship with your customers because you may avoid showing them “new customer” offers when they are already a high-value customer. Finally, the first-party cookie provides a consistent message across channels due to the higher retention factor. The advertiser can send the same message in an email and reinforce the message with display ads out on the web.

### Definitions

The following identification values are merely examples of values that may be used within one or more systems or processes described herein.

A network is a group of websites that are linked together. The links, for example, may include:

They belong to the same corporation

They have one company managing their website

They are linked together for marketing purposes (consortium)

A third-party network is a network that builds its own database with user information and stores that data within its own cookie.

A first-party network is a network of sites that either have a single domain hosted by a parent (corporation) or site with their own domains that work with one company to share user information within the parent family.

First-party network decision rules are rules for determining which advertising company gets an ad request. The decision rules, for example, may be based on the presence of one or more of the following:

A cookie within a first party domain

A cookie in a master domain with segmentation values favorable for that domain

No cookie and a domain is next in the rotation list

No cookie and a domain is in the list of default ads to be served.

### Scenarios

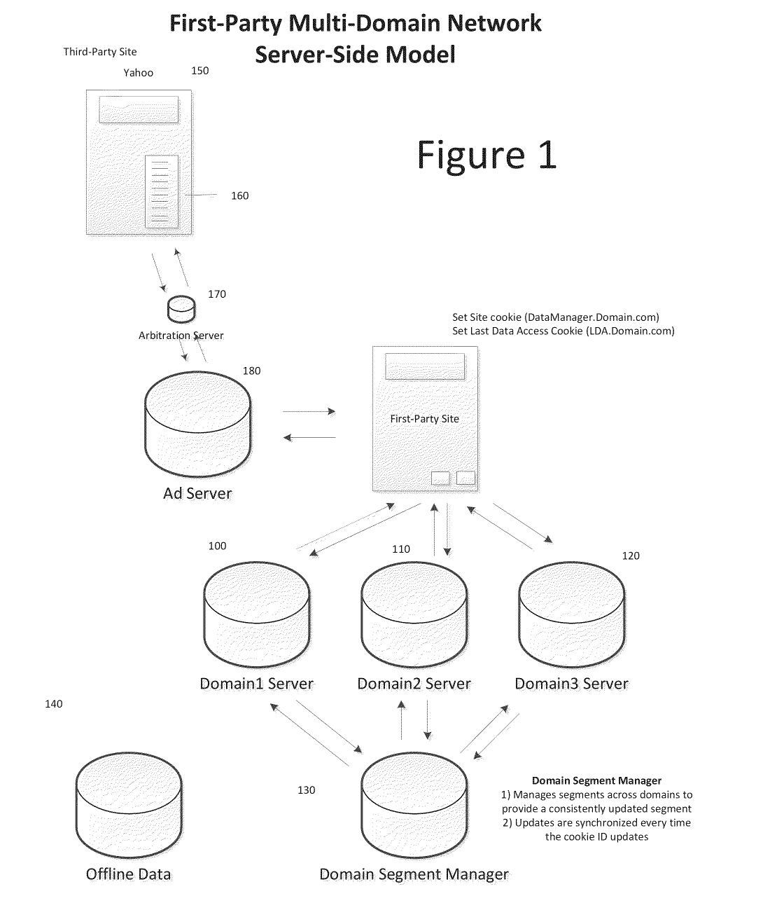

In one scenario (FIG. 1) an advertiser website has its own domain (multi-domain environment (Domain1.com (100), Domain2.com (110), Domain3.com (120))) and is affiliated with a trusted marketing partner (130) (consortium, direct mail, catalog, email, etc.) to interact with their existing customers and are tasked with generating new customers with the same interests as existing customers. The advertiser compiles user propensity and segmentation information on their customers. The propensity and segmentation information may be by single channel (e.g., Catalog) or across multiple contact channels (e.g., Catalog, Direct Mail, Email, etc.).

The propensity and segmentation information may be stored in a database or in a persistent browser function like a cookie or Local Shared Object. Since the advertiser has implemented the First-Party DNS functionality in their servers, they can set cookie information within their domain and an ad server can read the first-party domain advertiser cookie and leverage the propensity and segmentation information while running ads across the web. If the advertiser (100) adds a script from their trusted marketing partner (130) on their website (JavaScript, etc.) they can share the user propensity information with the marketing partner that can then be synchronized across all the other domains within the trusted partner network.

The marketing partner may initiate other offline efforts or campaigns on behalf of the Advertiser like catalog distribution and management, or direct mail campaigns to name a few. The marketing and data partner may collect more information from the user in their offline database (140) than is available online. The integration between the offline and online databases can be leveraged to calculate better propensity and segmentation scores. Once an overall view of the user is created it can be stripped of the Personally Identifiable Information (PII) and loaded back across all the partners in the trusted network to be able to target the users across the web in a first-party mode. In one implementation, the ad server team sends a special container ad tag (potentially JavaScript) (160) to the publisher (150) which has the ability to request ads from multiple domains. The ad server has multiple arbitration servers (170) and a process between the server farms to redirect the requests to the server (180) where the master was received. The requests will have a master request and zero or more slave requests with a common key to help the arbitration server recognize that the requests are from a single parent and facilitate the aggregation of requests. In one implementation, there is a process to provide a timeout function to limit the time to respond to the request as well as a process to arbitrate between multiple requests received. The process to arbitrate between the multiple requests may include determining which domain has the best segmentation information; which request has the best fit for the location context; which request needs to be served based on inventory reduction needs; and/or if a default ad needs to be served due to inventory or time constraints. This process preserves the first-party domain ad serve and enhances the efficacy of cookie-based targeting across multiple domains.

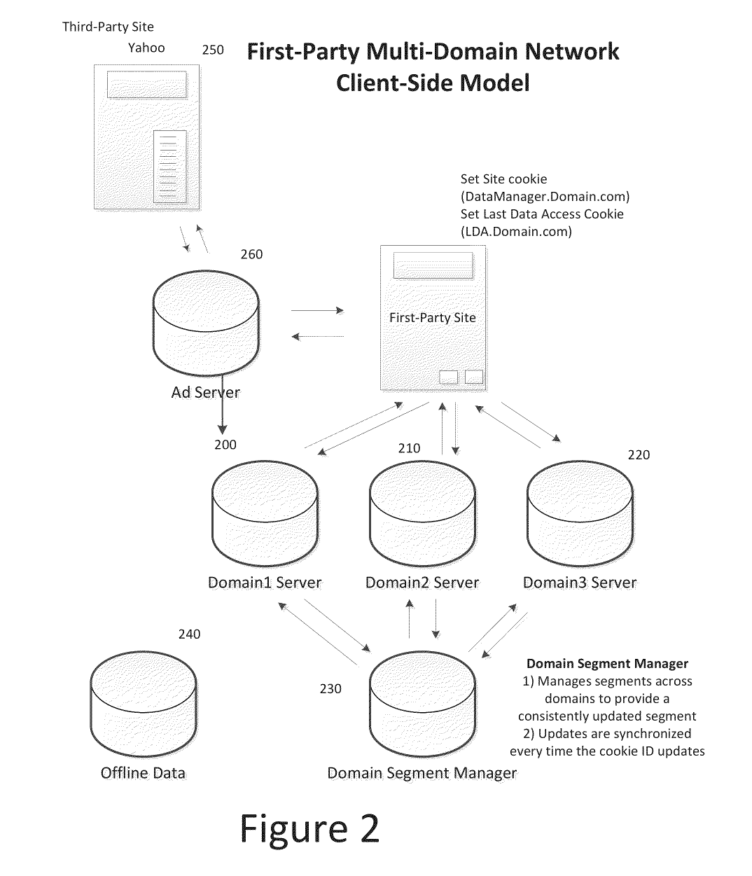

In another scenario (FIG. 2) an Advertiser website has their own domain (multi-domain environment (Domain1.com (200), Domain2.com (210), Domain3.com (220))) and is affiliated with a trusted marketing partner (230) (consortium, direct mail, catalog, email, etc) to interact with their existing customers and are tasked with generating new customers with the same interests as existing customers. The Advertiser compiles user propensity and segmentation information on their customers. The propensity and segmentation information may be by single channel (Catalog) or across multiple contact channels (Catalog, Direct Mail, Email, etc.).

The propensity and segmentation information may be stored in a database or in a persistent browser function like a cookie or Local Shared Object. Since the Advertiser has implemented the First-Party DNS functionality in their servers, they can set cookie information within their domain and an ad server can read the first-party domain advertiser cookie and leverage the propensity and segmentation information while running ads across the web. If the advertiser (200) adds a script from their trusted marketing partner (230) on their website (JavaScript, etc.) they can share the user propensity information with the marketing partner that can then be synchronized across all the other domains within the trusted partner network.

The marketing partner may initiate other offline efforts or campaigns on behalf of the Advertiser like catalog distribution and management, or direct mail campaigns to name a few. The marketing and data partner may collect more information from the user in their offline database (240) than is available online. The integration between the offline and online databases can be leveraged to calculate better propensity and segmentation scores. Once an overall view of the user is created it can be stripped of the Personally Identifiable Information (PII) and loaded back across all the partners in the trusted network to be able to target the users across the web in a first-party mode. The ad server team will send a special container ad tag (potentially JavaScript) (260) to the publisher (250) which has the ability to request ads from multiple domains. The Container tag script will request multiple domains from the Common/Consortium partners and, based on the response from the browser, determine which ads to serve. If one of the cookie jars contains a common cookie and a first-party advertiser cookie the browser will look at the Last Data Access (LDA) section of the cookie to determine which cookie contains the latest segmentation data and serve an ad based on that information. The script can also run the same logic across all the domains and subsequently update all the domain cookies at once to provide real-time cookie synchronization across the consortium partners. There is a process to arbitrate between multiple requests received. The process to arbitrate between the multiple requests includes determining which domain has the best segmentation information; which request has the best fit for the location context; which request needs to be served based on inventory reduction needs; and/or if a default ad needs to be served due to inventory or time constraints. This process preserves the first-party domain ad serve and enhances the efficacy of cookie-based targeting across multiple domains.

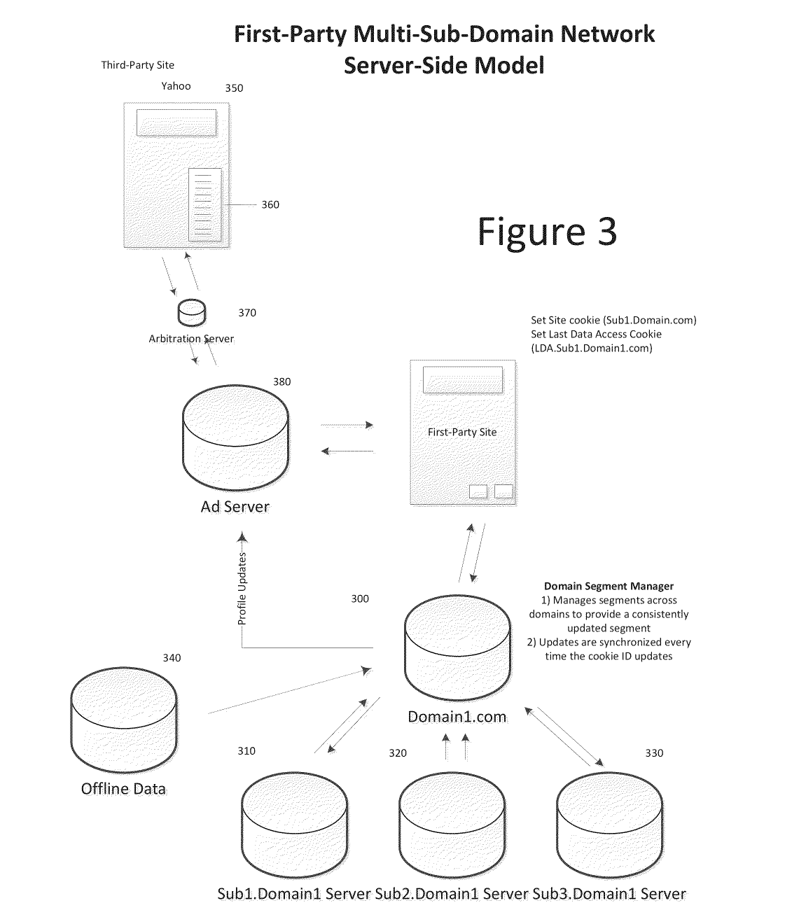

In a third scenario (FIG. 3), there are a number of companies that join a consortium (300) to share their anonymous user profiles to build a more comprehensive view of the user. In this scenario the companies do not retain or may not have their own website domains (multi-sub-domain environment: (Company1.Domain.com (310), Company2.Domain.com (320), Company3.Domain.com (330))) but share data by synchronizing their non-PII profile data with the consortium database and then receiving back the enhanced anonymous profile which includes data from all the consortium members and merged into the advertiser First-Party cookie or stored within a separate consortium-named cookie within the First-Party domain (consortium.Company1.Domain.com). The ad server (380) is setup with a DNS record/zone file entry for one or more of the advertisers, which enables the ad sever (380) to read and write cookies within those sub-domains. The ad server team will send a special container ad tag (potentially JavaScript) (360) to the publisher (350) which has the ability to request ads from multiple sub-domains. The Container tag script (360) will request multiple sub-domains from the Common/Consortium partners and, based on the response from the browser, pass the request(s) to the server (380) to determine which ads to serve. If one of the cookie jars contains a common cookie and a first-party advertiser cookie the browser will look at the Last Data Access (LDA) section of the cookie to determine which cookie contains the latest segmentation data and serve an ad based on that information. The script can also run the same logic across all the sub-domains and subsequently update all the sub-domain cookies at once to provide real-time cookie synchronization across the consortium partners. There is a process to arbitrate (370) between multiple requests received. The process to arbitrate (370) between the multiple requests includes determining which domain has the best segmentation information; which request has the best fit for the location context; which request needs to be served based on inventory reduction needs; and/or if a default ad needs to be served due to inventory or time constraints. This process preserves the first-party domain ad serve and enhances the efficacy of cookie-based targeting across multiple sub-domains.

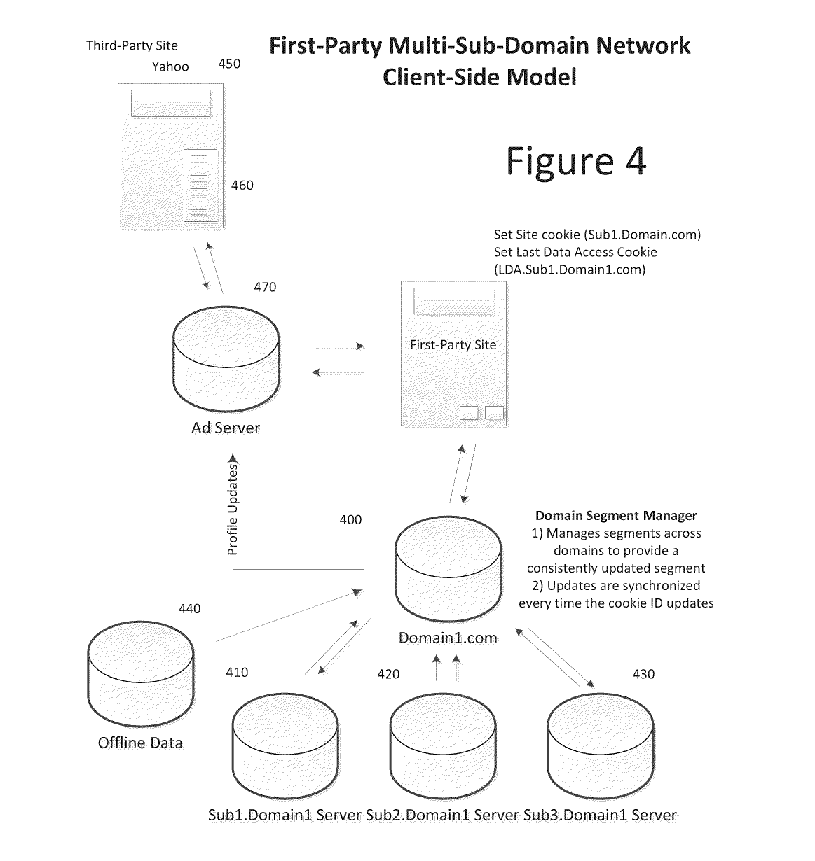

In a fourth scenario (FIG. 4), there are a number of companies that join a consortium (400) to share their anonymous user profiles to build a more comprehensive view of the user. In this scenario the companies do not retain or may not have their own website domains (multi-sub-domain environment: (Company1Domain.com (410), Company2Domain.com (420), Company3Domain.com (430))) but share data by synchronizing their non-PII profile data with the consortium database and then receiving back the enhanced anonymous profile which includes data from all the consortium members and merged into the advertiser First-Party cookie or stored within a separate consortium-named cookie within the First-Party domain (consortium.Company1Domain.com). The ad server is setup with a DNS record/zone file entry for one or more of the advertisers, which enables the ad sever to read and write cookies within those sub-domains. The ad server team will send a special container ad tag (potentially JavaScript) (460) to the publisher (450) which has the ability to request ads from multiple sub-domains. The Container tag script (460) will request multiple sub-domains from the Common/Consortium partners and, based on the response from the browser, determine which ads to serve within the script on the client-side. If one of the cookie jars contains a common cookie and a first-party advertiser cookie the browser will look at the Last Data Access (LDA) section of the cookie to determine which cookie contains the latest segmentation data and serve an ad based on that information. The script can also run the same logic across all the sub-domains and subsequently update all the sub-domain cookies at once to provide real-time cookie synchronization across the consortium partners. There is a process to arbitrate between multiple requests received. The process to arbitrate between the multiple requests includes determining which domain has the best segmentation information; which request has the best fit for the location context; which request needs to be served based on inventory reduction needs; and/or if a default ad needs to be served due to inventory or time constraints. This process preserves the first-party domain ad serve and enhances the efficacy of cookie-based targeting across multiple sub-domains.

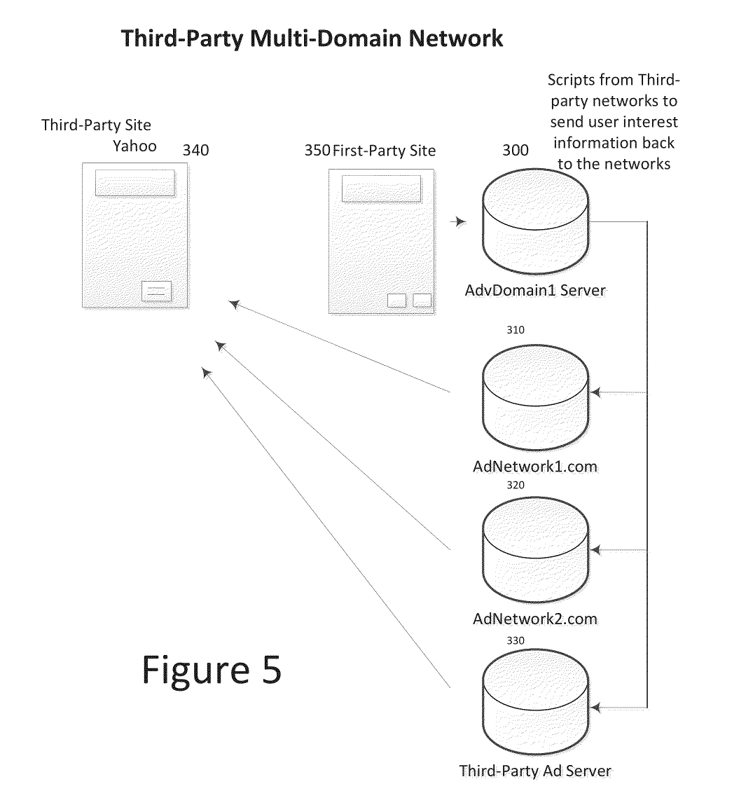

In another scenario (FIG. 5) a third-party model is provided as a comparison. In the traditional third-party model, the user visits the Advertiser site (550) which places scripts from Ad Networks (510, 520) and Third-Party Ad Servers (530) on their site (500) which capture user propensity and segmentation information in the third-party cookies. The Advertiser then works through the Ad Networks (510, 520) and Third-Party Ad Server (330) to run ads on Publisher sites (540). The Ad Networks (510, 520) aggregate the data from multiple Advertisers and use that information for targeting on the Publisher (540) site. The Advertiser provided their segmentation information to the Ad Network (510, 520) and Third-Party Ad Servers (530) which could be used to enable a competitor to target ads across the Ad Network (510, 520) or on Publisher sites (540).

### Exemplary Implementations

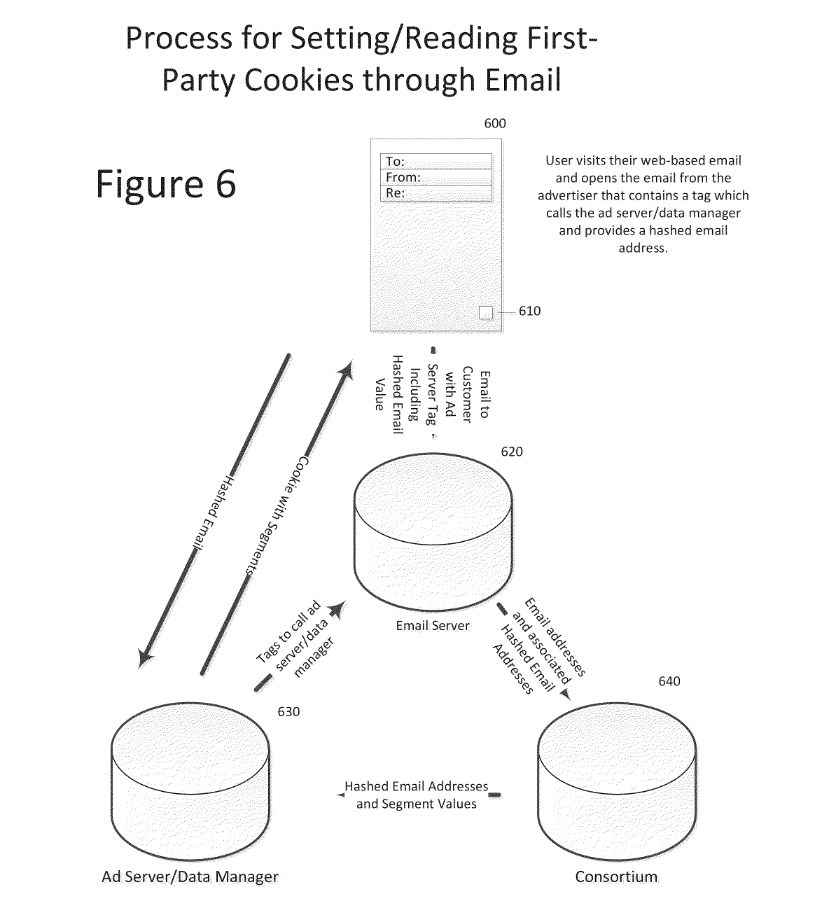

In an exemplary implementation (FIG. 6), the Consortium/Advertiser maintains a proprietary linking database (640) where offline and online data can be aggregated. The Consortium or Advertiser passes segmented, non-personally identifiable information (PII) to the data manager (630) along with a hashed email address which will act as a primary key for matching profiles so first-party cookies with the appropriate segmentation data can be sent to the browser. The ad server/data manager (630) sends a tag to the email company (620) with a generic field to be populated with the hashed email address that the email company (620) obtained from the Consortium/Advertiser. By passing the actual email address along with the hashed email address to the email vendor and only a hashed email value to the ad server/data manager (630) the Consortium/Advertiser (640) maintains privacy by not passing any PII data to the ad server/data manager (630). When the user opens their browser-based email the image call (610) goes to the ad server/data manager (630) delivering the hashed email address to the ad server/data manager (630). The ad server/data manager (630) then uses the hashed email address as a primary key to determine if there is a match and, if so, returns a cookie with the hashed emails address and any associated segmentation data.

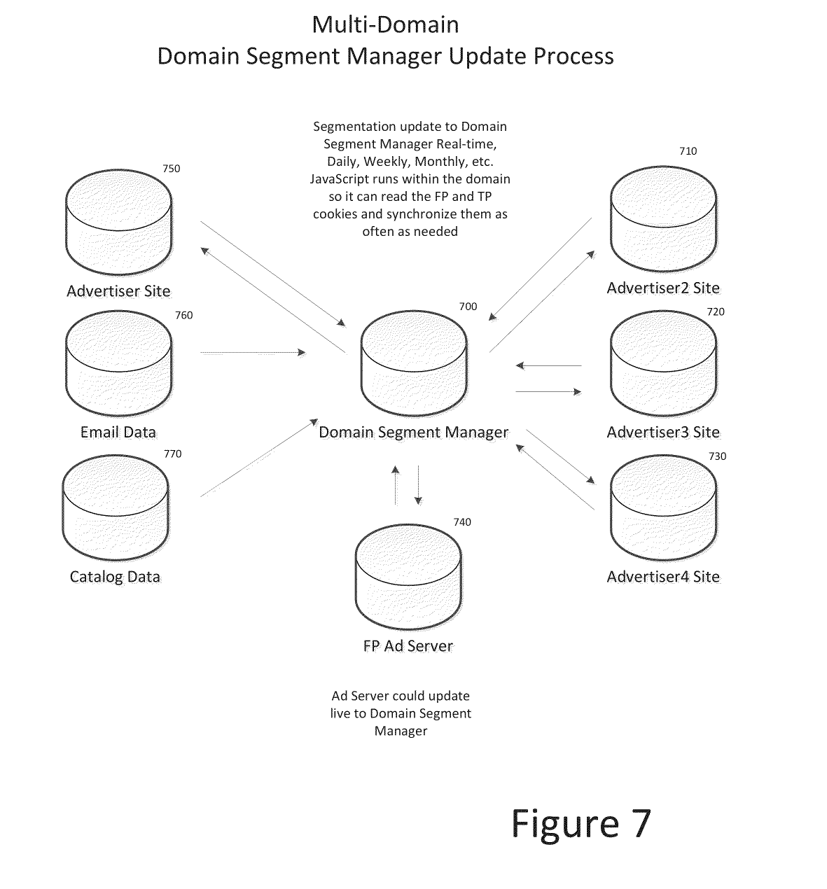

In yet another exemplary implementation, (FIG. 7) the Domain Segment Manager (700) is the “parent” database and controls the cookie profile updates across the consortium (710, 720, and 730) as well as the ad server (740). It can also accept additional information from other online and offline sources such as, email (760) and catalog (770) to name a few. Generally, the “child” databases will send their profiles to the parent on a scheduled or ad-hoc basis. A few examples without limitation would be (real-time 1-1, hourly, daily, weekly, monthly or ad hoc). Each profile contains a Last Data Access (LDA) flag to help determine which profile is the most recent. The domain segment manager database will merge the segments and then redistribute them to the “child” databases in one of the aforementioned manners and timeframes.

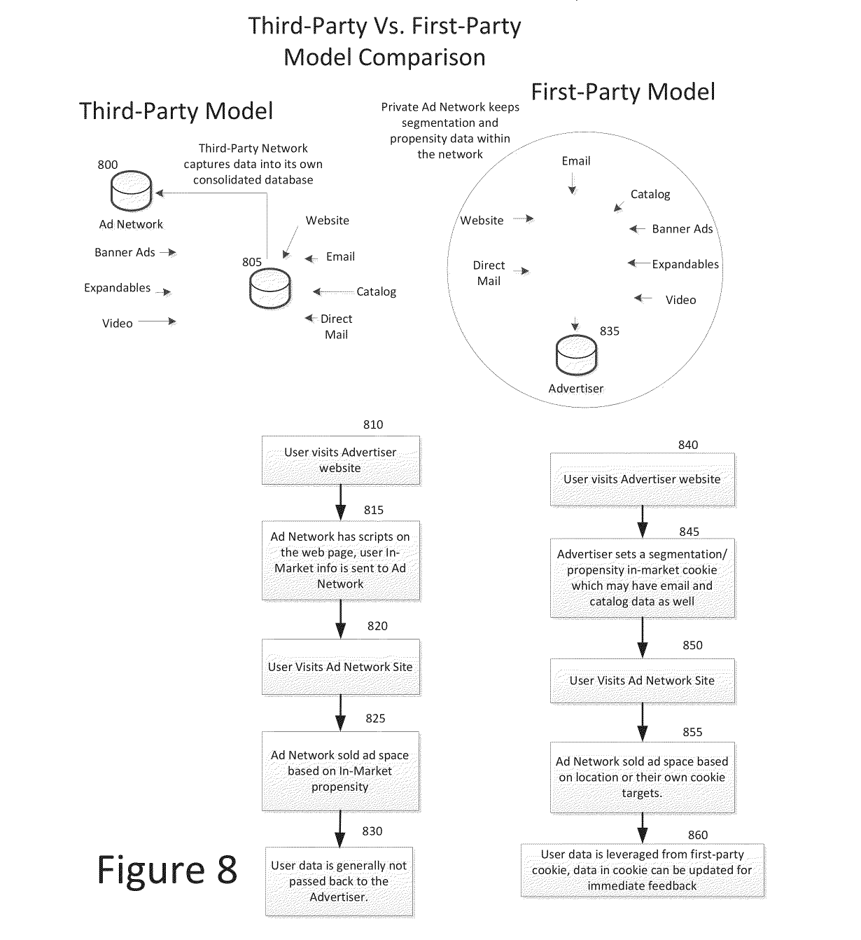

A distinction between the first-party and third-party models (FIG. 8) is that the first-party model acts on behalf of the advertiser and maintains the profiles within the domain or consortium whereas the third-party model acts on behalf of the ad network (800) and can read and write cookies in the Network domain (network1Domain.com). In the same third-party network/ad serving model the third-party ad server (800) sets cookies in their own domain (network1Domain.com) and does not work on behalf of the advertiser (805). Additionally, Third-party cookie ad servers are targeted by many anti-spyware programs for deletion and are susceptible third-party cookie blocking and rejection in browsers. In the flow chart, the user visits an Advertiser site (810) where the Ad Network (800) runs scripts that place their Ad Network (800) Cookie on the users' browser (815). When the user visits the Ad Network site (820) the Ad Network (800) reads the cookie and either serves an Ad to fulfill the request or sends the request to an Advertiser that purchased that segment/propensity (830).

In the First-Party model, a user visits the Advertisers website (835, 840). The Advertiser places a cookie on the users' browser along with its segmentation/propensity information (845). When the user visits the Ad Network (800) site the Ad Network either fulfills the ad request on their own or has sold the location to the Advertiser (830) which can then read the First-Party cookie (840) and place an ad based on the First-Party cookie data. No data is shared with the Ad Network (800).

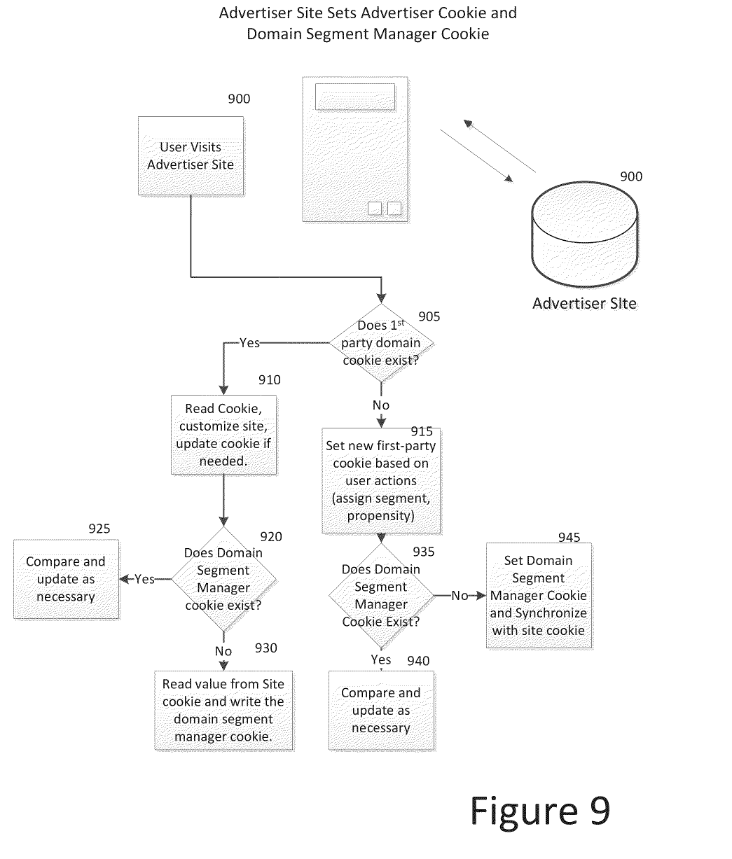

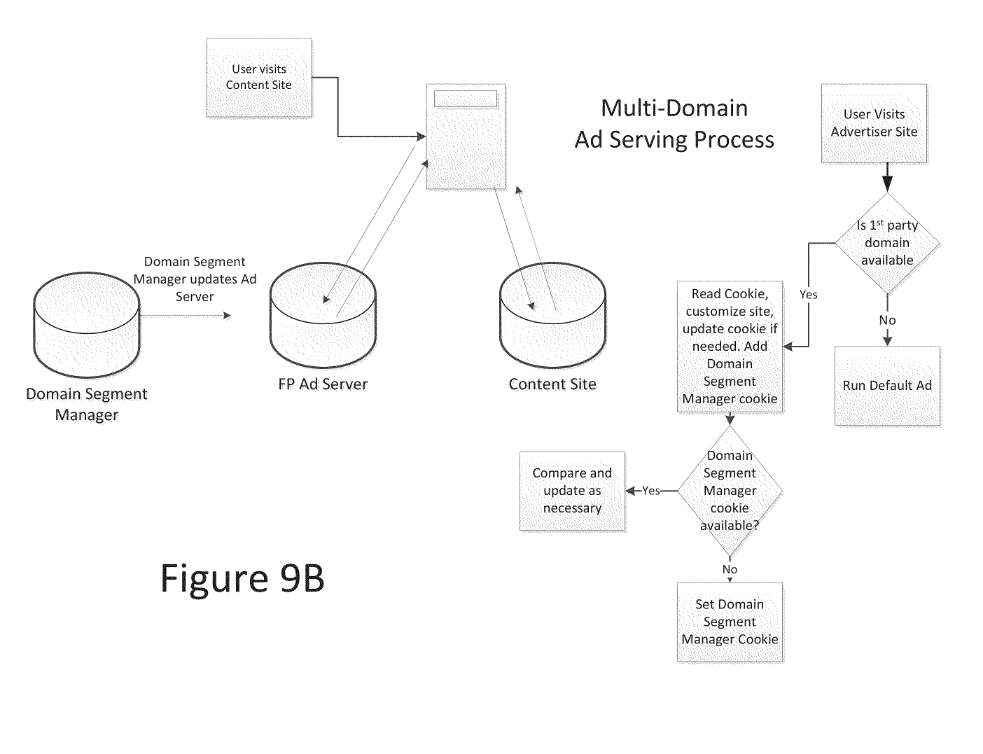

In yet another exemplary implementation, (FIG. 9) demonstrates how the Advertiser sets an Advertise First-Party cookie and a Domain Segment Manager First-Party Cookie. In this scenario, the user visits the Advertiser's site (900). The scripts are provided with the Advertiser Domain cookie jar and if there is an Advertiser Domain cookie available (910) it uses the information contained in the cookies to customize the site and subsequently update the cookie as needed. Secondarily, the script looks in the cookie jar for a Domain Segment Manager cookie (920). If the Domain Segment Manager Cookie exists it looks for the Last Data Access (LDA) flag and uses the cookie data or updates it with newer information as necessary. If no Domain Segment Manager cookie exists (930) the script tries to set the Domain Segment Manager cookie. If no First-Party Domain cookie exists (915), the script tries to set a cookie with its associated segmentation and propensity information. Secondarily, the script looks in the cookie jar for a Domain Segment Manager cookie (935). If the Domain Segment Manager Cookie exists (940) it looks for the Last Data Access (LDA) flag and uses the cookie data or updates it with newer information as necessary. If no Domain Segment Manager cookie exists (945) the script tries to set the Domain Segment Manager cookie.

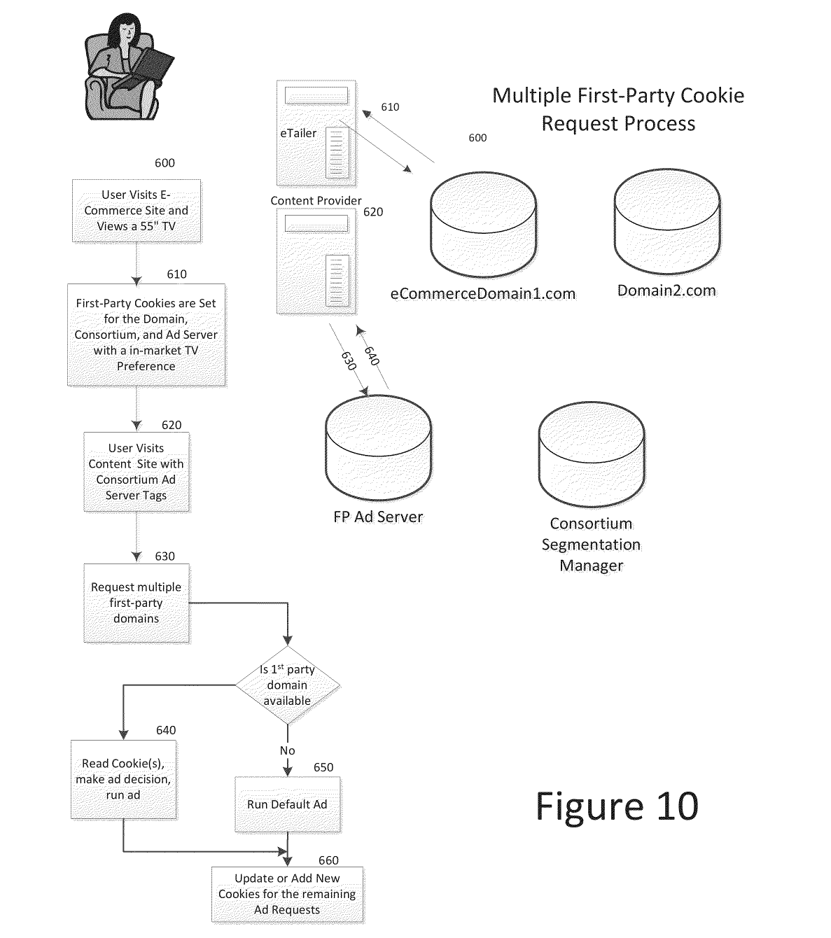

Yet another exemplary implementation may be understood in the context of a user visiting a website with its own domain like Domain1.com that has a first-party relationship with a first-party ad server (FIGS. 9B and 10). The first-party relationship enables the first-party ad server to read and write cookies in the first-party mode (ad.Domain1.com) to take advantage of advertiser owned behavioral and interest relationship data that the advertising company may store in their cookies (ad.Domain1.com=high_value) to serve relevant ads on their behalf. In a first-party multi-domain network consortium mode multiple separate domains share this behavioral and interest relationship information across the network through a Domain Segment Manager. In this scenario, a first-party domain cookie is set (DomMgr.Domain1.com=High_Value, DomMgr.Domain2.com=High_Value, etc) and synchronized with each domain that contains the behavioral and interest information. Every time the user visits the Domain1.com site three cookies are set or updated:

The Domain1.com cookie (Domain1.com=High_Value)

The Domain Segment Manager cookie (DomMgr1.com=High_Value)

The First-Party ad server cookie (ad.Domain1.com=High Value)

Domain1.com updates the Domain Segment Manager with new segmentation and propensity information as often as they decide is prudent. It could be a real-time synchronization, daily, weekly, monthly, etc. depending on how often the user visits the advertiser site, the amount of data to be sent and the capabilities of the Advertiser and Domain Segment Manager. In one scenario, the data is synchronized between the Advertiser and the Domain Segment manager real-time and then the Domain Segment manager can push out the updated segmentation data to all the other consortium members immediately. In another scenario, the updated segmentation and propensity data is sent from all the advertiser sites on a weekly basis and the Domain Segmentation manager compares the profiles to determine the most recently updated profile and then merge all the data and distribute an updated list.

In this implementation, the user visited the Advertiser website and received the first-party cookies in their cookie jar. It's possible that the cookies received from Advertiser1 didn't have detailed segmentation and propensity information but that the consortium cookie provided the information which was provided by Advertiser2. When the user surfs to a content site on the web where the Advertiser or Consortium purchased ad inventory the First-Party Advertiser or Consortium cookie is used to provide ads based on the segmentation/propensity data of the customer.

Within the user's browser there are privacy controls that enable the user to Reject all cookies, reject only third-party cookies, and/or accept all cookies. There are also anti-spam and spyware programs that identify third-party data collection cookies and schedule them for deletion. First-party cookies are less susceptible to deletion because users generally keep the first-party cookies to enable a better user experience when they visit the first-party site.

Internet ads are typically controlled by cookies placed on the browser and enable the ad serving company to control which ads are viewed by the user. Internet browsers continue to evolve and new devices continue to be introduced that can take advantage of internet access. Cookie-type functionality is also evolving into files and databases as evidenced, but not limited to, the growing popularity of companies using Adobe Flash™ Local Shared Objects and Microsoft Silverlight™ “Isolated Storage” capabilities. Generally accepted advertising principals like frequency of ad exposure, segmentation and propensity scores can be applied through these technologies to ensure that the user isn't exposed to the same ad too often and the most relevant ad is displayed thus reducing the possibility of ad burn-out.

On the behavioral and interest targeting side, the process of capturing user information is important to establish relevance and timeliness of ads being served to a user. For example, the fact that the user is looking at a 55″ LED Flat Panel TV may mean that they are “In Market” and ready to purchase. Capturing this interest and using it to serve relevant and timely ads can increase clicks on banners and therefore the Return on Ad Spend (ROAS) and/or Effective Cost Per Acquisition (eCPA) which helps prove the validity and cost effectiveness of internet advertising. The process is used on a daily basis but users, legislators, and government agencies like the FTC are becoming more aware of the user interest information being shared without the knowledge or consent of the users. Consequently, users are becoming more aware of browser controls to regulate or turn off browser cookies. At the same time legislators and the government agencies are looking to limit behavioral and interest data transfer without user knowledge and consent.

### Exemplary Computer System

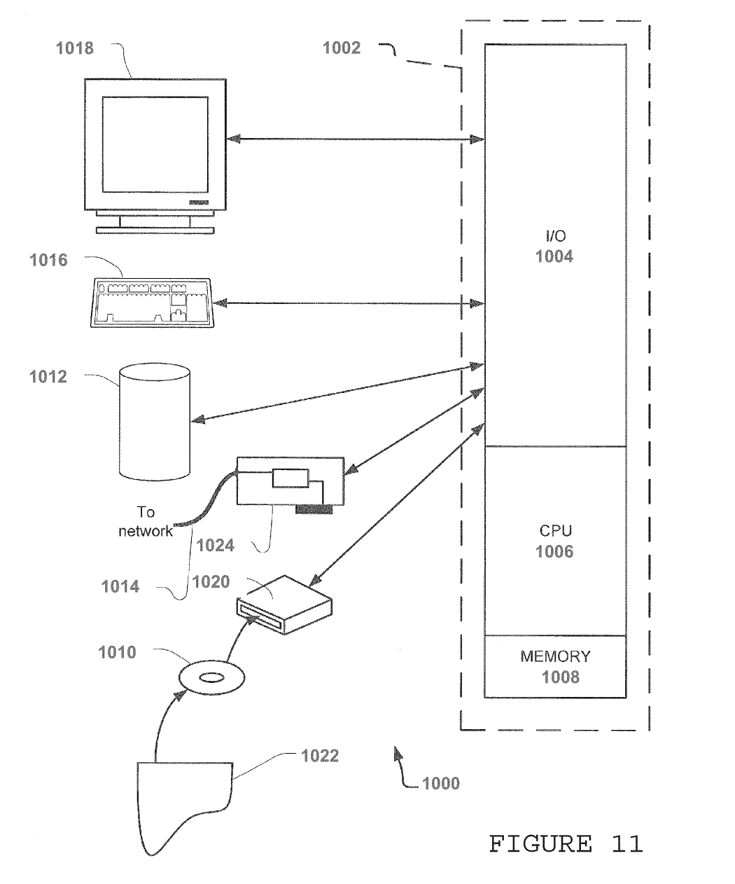

In one implementation, any one or more processes may be performed on a computing device, such as the one shown in FIG. 11. In this example, a computing device 1000 includes a bus 1001, at least one processor 1002, at least one communication port 1003, a main memory 1004, a removable storage media 1005 a read only memory 1006, and a mass storage 1007. Processor(s) 1002 can be any know processor, such as, but not limited to, an Intel® Itanium® or Itanium 2® processor(s), or AMD® Opteron® or Athlon MP® processor(s), or Motorola® lines of processors. Communication port(s) 1003 can be any of an RS-232 port for use with a modem based dialup connection, a 10/100 Ethernet port, or a Gigabit port using copper or fiber. Communication port(s) 1003 may be chosen depending on a network such a Local Area Network (LAN), Wide Area Network (WAN), or any network to which the computing device 1000 connects. The computing device 1000 may be in communication with peripheral devices (not shown) such as, but not limited to, printers, speakers, cameras, microphones, or scanners.

Main memory 1004 can be Random Access Memory (RAM), or any other dynamic storage device(s) commonly known in the art. Read only memory 1006 can be any static storage device(s) such as Programmable Read Only Memory (PROM) chips for storing static information such as instructions for processor 1002. Mass storage 1007 can be used to store information and instructions. For example, hard disks such as the Adaptec® family of SCSI drives, an optical disc, an array of disks such as RAID, such as the Adaptec family of RAID drives, or any other mass storage devices may be used.

Bus 1001 communicatively couples processor(s) 1002 with the other memory, storage and communication blocks. Bus 1001 can be a PCI/PCI-X or SCSI based system bus depending on the storage devices used. Removable storage media 1005 can be any kind of external hard-drives, floppy drives, IOMEGA® Zip Drives, Compact Disc-Read Only Memory (CD-ROM), Compact Disc-Re-Writable (CD-RW), Digital Video Disk-Read Only Memory (DVD-ROM).

The embodiments of the invention described herein are implemented as logical steps in one or more computer systems. The logical operations of the present invention are implemented (1) as a sequence of processor-implemented steps executing in one or more computer systems and (2) as interconnected machine or circuit modules within one or more computer systems. The implementation is a matter of choice, dependent on the performance requirements of the computer system implementing the invention. Accordingly, the logical operations making up the embodiments of the invention described herein are referred to variously as operations, steps, objects, or modules. Furthermore, it should be understood that logical operations may be performed in any order, unless explicitly claimed otherwise or a specific order is inherently necessitated by the claim language.

The above specification, examples and data provide a complete description of the structure and use of exemplary embodiments of the invention. Since many embodiments of the invention can be made without departing from the spirit and scope of the invention, the invention resides in the claims hereinafter appended. Furthermore, structural features of the different embodiments may be combined in yet another embodiment without departing from the recited claims.

In some implementations, articles of manufacture are provided as computer program products. One implementation of a computer program product provides a transitory or non-transitory computer program storage medium readable by a computer system and encoding a computer program. Another implementation of a computer program product may be provided in a computer data signal embodied in a carrier wave by a computing system and encoding the computer program.

Furthermore, certain operations in the methods described above must naturally precede others for the described method to function as described. However, the described methods are not limited to the order of operations described if such order sequence does not alter the functionality of the method. That is, it is recognized that some operations may be performed before or after other operations without departing from the scope and spirit of the claims.

Although multiple implementations of this invention have been described above with a certain degree of particularity, those skilled in the art could make numerous alterations to the disclosed embodiments without departing from the spirit or scope of this invention. All directional references (e.g., upper, lower, upward, downward, left, right, leftward, rightward, top, bottom, above, below, vertical, horizontal, clockwise, and counterclockwise) are only used for identification purposes to aid the reader's understanding of the present invention, and do not create limitations, particularly as to the position, orientation, or use of the invention. Joinder references (e.g., attached, coupled, connected, and the like) are to be construed broadly and may include intermediate members between a connection of elements and relative movement between elements. As such, joinder references do not necessarily infer that two elements are directly connected and in fixed relation to each other. It is intended that all matter contained in the above description or shown in the accompanying drawings shall be interpreted as illustrative only and not limiting. Changes in detail or structure may be made without departing from the spirit of the invention as defined in the appended claims.

We claim:

1. A method comprising:
receiving an advertisement serving request at a server from a content provider directed to an adserver within a first party domain of an advertiser;
receiving data from a client system set within the first party domain, the data comprising at least one of propensity information and segmentation information; and
synchronizing at least a portion of the data set within the first party domain to data associated with a second domain related to the first party domain.

2. The method of claim 1 wherein the second domain comprises a parent domain of the first party domain.

3. The method of claim 1 wherein first party domain and the second domain are domains of related companies.

4. The method of claim 1 wherein the first party domain and the second domain each comprise child domains of a common parent domain.

5. The method of claim 1 wherein the operation of synchronizing the data set within the first party domain comprises synchronizing data set within a first party sub-domain of the first party domain to data set within the first-party domain.

6. The method of claim 5 wherein the first party domain network comprises a parent domain of the first-party sub-domain.

7. The method of claim 1 wherein the data comprises persistent browser information.

8. The method of claim 7 wherein the persistent browser information comprises at least one of the group comprising: a cookie, a cookie set within the domain of the advertiser, a local shared object, data stored in a database, data stored in a database residing on the client system, data stored in a cookie jar, data stored in a database residing on a server, data stored in a database residing on a server external to the client system, data stored in a database residing on a server internal to the client system.

9. The method of claim 1 wherein the data comprises data stored in a uniform resource locator (URL) of the advertisement serving request.

10. The method of claim 1 further comprising accessing the data set within the first party domain via an adserver operating within the first party domain.

11. The method of claim 10 wherein the adserver is operating within a delegated sub-domain of the first party domain.

12. The method of claim 1 further comprising accessing the data set within the first party domain via an adserver operating within the first party domain.

13. The method of claim 12 wherein the adserver is operating within a delegated sub-domain of the first party domain.

14. The method of claim 1 further comprising providing an advertisement based upon the data received from the client system.

15. The method of claim 1 further comprising providing an advertisement based upon the data set within the second domain.

16. The method of claim 15 wherein the advertisement is provided based upon the data set within the second domain synchronized with the data received from the client system.

17. The method of claim 1 wherein the data set within the first party domain is synchronized to data set within the second domain via a script.

18. The method of claim 17 wherein the script is executed on a web page of the content provider.

19. The method of claim 1 wherein the data set within the first party domain is synchronized to data set within the second domain off-line.

20. The method of claim 1 wherein the data set within the second domain is used to provide at least one of on-line advertising and off-line advertising.

21. The method of claim 1 wherein the data set within the second domain integrates on-line and offline data.

22. The method of claim 1 further comprising removing personally identifiable information from the data set within the second domain.

23. The method of claim 1 further comprising providing an ad tag to request ads from multiple domains.

24. The method of claim 23 wherein the ad tag comprises at least one of a special container ad tag and a JavaScript ad tag.

25. The method of claim 1 wherein the synchronization is performed via at least one arbitration server.

26. The method of claim 1 wherein the synchronization is performed via arbitration between multiple requests received.

27. The method of claim 26 wherein the arbitration comprises determining a domain based upon at least one of the group comprising: segmentation information, best fit, best fit for location, inventory reduction, inventory constraints, and time constraints.

28. The method of claim 1 wherein the operation of receiving comprises receiving data from a client system set within the first party domain and from a third party, the data comprising at least one of propensity information and segmentation information.

29. The method of claim 28 wherein the data received from the third party is set within a partner domain of the first party domain.

30. A method comprising:
requesting content from a server via a network, wherein the content includes an advertisement served on behalf of an advertiser;
providing data from a client system set within a first party domain of the advertiser in response to a request from an adserver operating within the first party domain, the data comprising propensity and/or segmentation information;
receiving updated data set within the first party domain at the client; and
synchronizing at least a portion of the data set within the first party domain to data associated with a second domain related to the first party domain.

31. The method of claim 30 wherein the second domain comprises a parent domain of the first party domain.

32. The method of claim 30 wherein first party domain and the second domain are domains of related companies.

33. The method of claim 30 wherein the first party domain and the second domain each comprise child domains of a common parent domain.

34. The method of claim 30 wherein the updated data is set within a sub-domain of the first party domain.

35. The method of claim 34 wherein the second domain comprises a parent domain of the first-party sub-domain.

36. The method of claim 30 wherein the updated data comprises a first-party cookie and at least a portion of the first party cookie is synchronized to a second domain cookie.

37. A system comprising:
an ad server configured to (i) receive an advertisement serving request from a content provider directed to the ad server within a first party domain of an advertiser, (ii) receive data from a client system set within the first party domain, the data comprising at least one of propensity information and segmentation information; and (iii) synchronize at least a portion of the data set within the first party domain to data associated with a second domain related to the first party domain.
